(19) United States
(12) Patent Application Publication
(10) Pub. No.: US 2023/0070088 A1
(43) Pub. Date: Mar. 9, 2023

(54) A HEAT-BONDABLE PRINTED LAMINATE AND RELATED METHODS

(71) Applicant: Avery Dennison Retail Information Services LLC, Mentor, OH (US)

(72) Inventors: James J. DEININGER, Highland Heights, OH (US); Danielle L. KRAMER, Mentor, OH (US); Christopher MAIO, Wickliffe, OH (US); Michelle PEARCE, Chardon, OH (US); Christopher PILLSBURY, Willoughby, OH (US); Shawn P. ROBERTS, South Euclid, OH (US)

(21) Appl. No.: 17/758,043

(22) PCT Filed: Dec. 29, 2020
(86) PCT No.: PCT/US2020/067363

§ 371 Date: Jun. 27, 2022

Related U.S. Application Data
(60) Provisional application No. 62/954,525, filed on Dec. 29, 2019.
(60) Provisional application No. 62/954,523, filed on Dec. 29, 2019.

(51) Int. Cl. C09J 7/29; B41M 5/00; B41M 7/00; B32B 27/08; C09J 7/35; C09J 5/06

(52) U.S. Cl. CPC C09J 7/29; B41M 5/0011; B41M 7/009; B32B 27/08; C09J 7/35; C09J 5/06; B32B 2255/26; B32B 2255/10; B32B 2405/00; C09J 2203/358; C09J 2301/304; C09J 2467/006; C09J 2475/006; C09J 2433/006; C09J 2400/266

(57) ABSTRACT

In some embodiments, a printed laminate comprises a first substrate having a first side and a second side, an ink layer at least partially adhered through direct printing to the first side of the first substrate, and a second substrate comprising a heat activatable adhesive and having a first side and a second side. The first side of the second substrate may be at least partially laminated to the second side of the first substrate.

### CROSS-REFERENCE TO RELATED APPLICATIONS

This application claims the benefit of U.S. Provisional Patent Application Nos. 62/954,523 filed Dec. 29, 2019, and 62/954,525 filed Dec. 29, 2019, both of which are incorporated herein by reference in their entireties.

### BACKGROUND

There is a significant commercial interest in methods, devices, and systems for attaching labels, designs, logos, trademarks, symbols, product identifications, or other images on garments, finished fabrics (e.g., towels, bed linens, tablecloths, etc.), and other materials. Such images, text, or designs may include vibrant colors and/or unique shapes and may be intended to be permanently affixed to various materials.

Traditionally, print may be applied to fabrics using direct fabric printing, which may include use of a block or stencil having a design to guide the printing process as color is applied directly to the fabric. Screen printing is a well-established method of direct fabric printing wherein a screen material, such as mesh or silk, is prepared in the shape of the desired design and stretched over the fabric using a large screen. Any portion of the fabric not to receive the print is covered, and ink or dye is worked through the screen into the exposed fabric. Unfortunately, screen printing may be labor intensive and lacking in precision, such that it may be inappropriate for high resolution images or intricate designs. Additionally, a new screen or stencil may be required for each design, potentially making the technology expensive and incompatible with small orders.

Another approach is a thermal transfer printing method, in which a dye or ink is applied to a transfer medium before being transferred from the medium to the fabric by exposure to heat. However, current practices may be limited in that the dye may fail to penetrate a fabric deeply enough for the design to show clearly, may not work for dark fabrics, and may leave residue on fabric, depending on the materials used. Some methods may also use layers that fade, leading to reduced visual quality.

Finally, some methods use sublimation ink. However, sublimation ink may be very costly, and may be restricted to a narrow variety of fabric compositions.

Therefore, there exists a long felt need to develop improved methods for applying images.

### SUMMARY

Multiple aspects of this disclosure may be embodied separately or together in the devices and systems described and claimed below. These aspects may be employed alone or in combination with other aspects of the subject matter described in the summary, the detailed description, and the claims, and the description of these aspects in various embodiments is not intended to preclude the use or claiming of these aspects separately or in different combinations.

In some embodiments, a heat-bondable printed laminate may include an ink layer having a first side configured for viewing and a second side, a first substrate having a first side and a second side, the second side of the ink layer being at least partially adhered through direct printing to the first side of the first substrate, and a second substrate may include a heat activatable adhesive and having a first side and a second side, the first side of the second substrate being at least partially laminated to and disposed on the second side of the first substrate.

In some embodiments, the printed laminate may include a coating at least partially disposed between the first side of the first substrate and the second side of the ink layer. The thickness of the coating may be in the range of 0.5 mil to 25 mil. The coating may be vinyl containing polymeric film. The first substrate may include a single layer polymeric film. The first substrate may include a multi-layer polymeric laminate.

In some embodiments, the first substrate may be formed from a material selected from the group consisting of a polyurethane, a polyester, and polyethylene terephthalate and combinations thereof. The ink may be at least one selected from water based ink, solvent based ink, latex ink and eco-solvent ink. The ink may include eco-solvent ink. The ink may include polyurethane ink, polyacrylate ink, or combinations thereof. The ink layer may include one color. The ink layer may include more than one color. The adhesive layer may include heat activatable adhesive. The heat activatable adhesive coating may be activated at a temperature in the range of 270 to 370° F. The adhesive coating may include a polyurethane adhesive, a polyester adhesive, or combinations thereof.

In some embodiments, a method of manufacturing a heat-bondable laminate, may include printing an ink layer onto a first side of a first substrate, curing the ink at a temperature in the range of 200° to 300° F., disposing a first side of a second substrate in contact with a second side of the first substrate, the second substrate may include a heat activatable adhesive and having a first side and a second side onto the first substrate, and laminating the first substrate and the second substrate together.

In some embodiments, the first substrate and the second substrate are laminated together before the ink layer may be printed onto the first substrate. The first substrate and the second substrate are laminated together after the ink layer may be printed onto the first substrate. The ink may be digitally printed onto the first substrate. The method further may include applying a coating on the first side of the first substrate before printing the ink layer. The coating may include vinyl containing polymeric film having thickness in the range of 0.5 to 25 mils. The first substrate may be formed from a material selected from the group consisting of a polyurethane, a polyester, and polyethylene terephthalate and combinations thereof. The ink may be at least one selected from water based ink, solvent based ink, latex ink and eco-solvent ink.

In some embodiments, the ink layer may include polyurethane ink, polyacrylate ink, or combinations thereof. The second substrate includes an adhesive may include a polyurethane adhesive, polyester adhesive, or combinations thereof. A method for applying an image to a material, the method may include positioning a heat-bondable laminate, over a material, the heat-bondable laminate having an ink layer, a first substrate, and a second substrate, the ink layer having a first side configured for viewing and a second side at least partially adhered to a first side of the first substrate, the first substrate having a second side at least partially laminated to a first side of the second substrate that may include a heat activatable adhesive, the positioning of the heat-bondable laminate placing the second side of the second substrate in contact with the material, applying heat and pressure to the printed laminate and the material to bond the printed laminate to the material,

In some embodiments, the heat applied to the printed laminate and the material may be between 270 and 370° F. The pressure applied to the printed laminate and the material may be at least 40 psi. The heat and pressure may be applied to the printed laminate and the material for time in the range of 10 to 50 seconds. The may include cotton, polyester, a blend of cotton and polyester, fabric, wood, glass, metal, plastic, cardboard, ceramic, or carbon fiber. The heat and pressure may be applied to the printed laminate and the material for time exceeding 10 seconds.

### BRIEF DESCRIPTION OF THE DRAWINGS

FIG. 1 is an exemplary diagram of a heat bondable printed laminate, in accordance with some embodiments;

FIG. 2 is another exemplary diagram of a heat bondable printed laminate, in accordance with some embodiments;

FIG. 3A-3B are exemplary diagrams of a method of manufacturing a heat-bondable laminate, in accordance with some embodiments;

FIG. 4A-4B are exemplary diagrams of a method of manufacturing a heat-bondable laminate, in accordance with some embodiments;

FIG. 5A-5C are exemplary diagrams of a method of manufacturing a heat-bondable laminate, in accordance with some embodiments;

FIG. 6 is an exemplary diagram of the application of a heat bondable printed label to a material, in accordance with some embodiments; and

FIG. 7 is a top plan view of a material with a printed label in accordance with some embodiments.

### DETAILED DESCRIPTION

Various aspects of the disclosure are discussed in the following description and related drawings, and alternate embodiments may be devised without departing from the spirit or the scope of the invention. Additionally, some known elements may be omitted or may not be described in detail to avoid obscuring relevant details.

As used herein, the word “exemplary” means “serving as an example, instance or illustration.” The embodiments described herein are not limiting, but rather are exemplary only, and the described embodiments are not necessarily preferred or advantageous over other embodiments. Moreover, the terms “embodiments of the invention”, “embodiments” or “invention” do not require that all embodiments of the invention include the discussed feature, advantage or mode of operation.

In some embodiments, a heat-bondable laminate is disclosed that may include one or more of a first substrate having a first side and a second side, an ink layer at least partially adhered through direct printing to the first side of the first substrate, and a second substrate comprising a heat activatable adhesive and having a first side and a second side. The first side of the second substrate may be at least partially laminated to and disposed on the second side of the first substrate. In some exemplary embodiments, a coating may be at least partially disposed between the first side of the first substrate and the second side of the ink layer.

In some embodiments, the coating may include or consist of vinyl containing polymeric film. In some embodiments, the thickness of the coating may be between 0.5 mil to 25 mil, from 0.5 to 1 mil, from 1 mil to 5 mil, from 5 to 10 mil, from 10 mil to 15 mil, from 15 mil to 20 mil and from 20 mil to 25 mil. In some embodiments, the coating may be between 0-0.5 mil, 25-50 mil, 50-100 mil, or 100-200 mil. In terms of upper limits, the thickness of the coating can be less than 25 mil, less than 20 mil, less than 15 mil. In terms of lower limits, the thickness of the coating can be at least 0.5 mil, at least 1 mil, at least 5 mil, or greater. Mil is a unit of thickness and corresponds to thousandth of an inch that is 0.001 inch.

In some embodiments, the first substrate may be formed from a material selected from the group consisting of a polyurethane, a polyester, and polyethylene terephthalate and combinations thereof. In various embodiments, one or more of the materials listed above may provide advantages over some other materials by having one or more of better mechanical properties or better ability to receive and bond with inks used for printing. Some of the materials may also provide improvement with respect to heat resistance, such as by having better resistance to softening and/or becoming tacky under increased temperatures that may be encountered during heating to apply an adhesive to a material and to accomplish heat bonding. In some other embodiments, one or more of the materials listed above may have improved optical clarity, which may assist orienting a printed design just prior to being affixed to a surface. In an exemplary embodiment, the first substrate is at least partially or entirely composed of polyurethane film. Some additional embodiments may use polyethylene and non-oriented polypropylene to form part or all of one or more substrates such as the first substrate or the second substrate.

In some embodiments, the first substrate comprises a single layer polymeric film. In other embodiments, the first substrate comprises a multi-layer polymeric laminate. Multilayer polymeric laminate typically comprises more than one layer of polyurethane, a polyester, and polyethylene terephthalate or combinations thereof laminated together.

The ink may comprise or consist of at least one or a water based ink, a solvent based ink, a latex ink, and an eco-solvent ink. The nature of the ink used by the digital printer may vary without departing from the scope of the present disclosure. The ink may include polyurethane ink, polyacrylate ink, or combinations thereof.

In some embodiments, the ink is or includes eco-solvent ink. Eco-solvent ink may have the vibrant color and high color reproducibility of some solvent inks, and may allow for printing on a wide range of materials including PVC, paper, fabric, and PET film without the ink absorbing layer, which may be difficult to print on with solvent ink. Eco-conscious low VOC (volatile organic compounds) formulation ink may not require special ventilation in the workplace, and may therefore, reduces any adverse operator health effects.

In some embodiments, a SOLJET® Pro III XC-540 digital printer may be used to apply ECO-SOL® ink (which is an eco-solvent ink) to the first substrate. In another exemplary embodiment, a SURECOLOR® SC-S40600 digital printer was used to apply ULTRACHROME® GS3 ink (which is an eco-solvent ink) to the first substrate. In some embodiments, the ink layer can comprise one color. In alternate embodiments, the ink layer comprises more than one color, typically selected from CMYK (cyan, magenta, yellow, and black) color. The present disclosure provides the printed labels for fabrics which don't fade or peel off even after 25 wash cycles.

In some embodiments, the second substrate includes heat activatable adhesive. In some embodiments, the heat activatable adhesive is activated at a temperature in the range of 220 to 370° F. Typical temperature ranges in this regard are between approximately 220° F. and approximately 360° F., or approximately 230° F. and approximately 350° F., or approximately 240° F. and approximately 340° F., or approximately 250° F. and approximately 330° F., or approximately 260° F. and approximately 320° F., or approximately 270° F. and approximately 310° F., or approximately 280° F. and approximately 300° F. In terms of upper limits, the temperature can be less than 370° F., less than 350° F., less than 330° F., less than 310° F. or less than 300° F. In terms of lower limits, the temperature can be at least 220° F., at least 240° F., at least 350° F. or at least 270° F.

In some embodiments, the adhesive comprises a polyurethane adhesive, polyester adhesive, or combinations thereof. In some embodiments, the adhesive of the second substrate is a solid adhesive sheet. The solid adhesive sheet has better uniformity, smoothness, which enhances speed of application on the polymeric film of the first substrate with consistent thickness, and adhesion. Further the solid adhesive sheet is easier to handle, can be laminated to the other layers, and overall improves manufacturing efficiency. In alternate embodiments, the adhesive of the second substrate is powdered adhesive or liquid adhesive.

In some embodiments, a printed label is provided, wherein the ink may be digitally printed on to the polymeric film, which obviates use of the transfer medium or the release layer/coatings in the printed label. Further, the printed label may provide for improved efficiency, image quality, and precision.

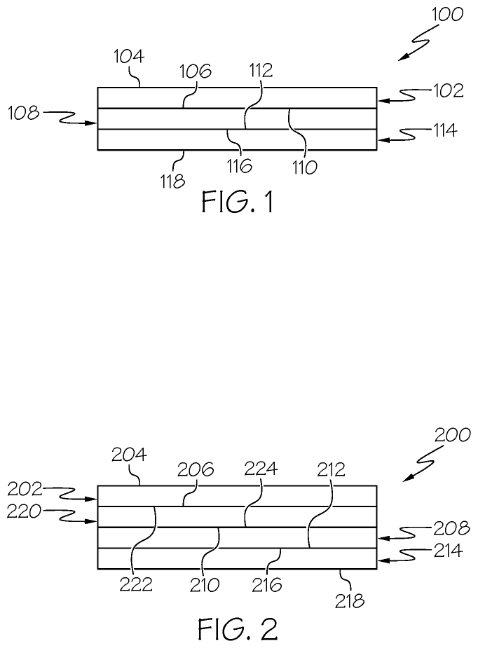

In some embodiments, such as in FIG. 1, a heat bondable printed label 100 is provided. In some embodiments, a heat-bondable label 100 comprises a first substrate 108 having a first side 110 and a second side 112; an ink layer 102 at least partially adhered through direct printing to the first side 110 of the first substrate 108; and a second substrate 114 comprising a heat activatable adhesive and having a first side 116 and a second side 118. The first side 116 of the second substrate 114 may be at least partially laminated to and disposed on the second side 112 of the first substrate 108.

In some embodiments, such as in FIG. 2, a heat bondable printed label 200 includes a coating. For example, the coating 220 may be at least partially disposed between the first side 210 of the first substrate 208 and the second side 206 of the ink layer 202. In various embodiments, the heat bondable printed label 200 may include a first substrate 208 having a first side 210 and a second side 212; a coating 220 at least partially disposed on the first side 210 of the first substrate 208 and having a first side 222 and a second side 224, the second side 224 being at least partially adhered to the first substrate 208; an ink layer 202 at least partially adhered through direct printing to the first side 222 of the coating 220; and a second substrate 214 comprising a heat activatable adhesive and having a first side 216 and a second side 218, wherein the first side 216 of the second substrate 214 is at least partially laminated to and disposed on the second side 212 of the first substrate 208.

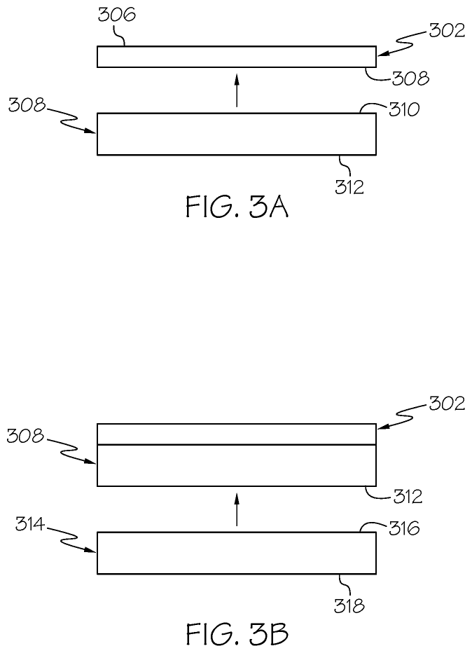

In various embodiments, a method of manufacturing a heat-bondable laminate is disclosed. For example, FIGS. 3A-3B illustrate an embodiment of method of manufacturing a heat-bondable laminate is shown. In FIG. 3A, the ink layer 302 may be at least partially adhered through digital printing onto a first side 310 of a first substrate 308. In a subsequent operation, the ink may be cured by heating the first substrate 308 at a temperature in the range of 200° to 300° F. In some embodiments, as shown in FIG. 3B, a second substrate 314 comprising a heat activatable adhesive and having a first side 316 and a second side 318 may be adhered to the first substrate 308, such that the first side 316 of the second substrate 314 is in contact with the second side 312 of the first substrate 308. The first substrate 308 and the second substrate 314 may be laminated together, which may result in a heat bondable printed laminate in accordance with some embodiments. In various embodiments, the first substrate 308 and the second substrate 314 may be laminated together either before or after the ink layer 302 is printed onto the first substrate. In some embodiments, a coating 222 is disposed at least partially between the first side 310 of the first substrate 308 and the second side 306 of the ink layer 302. For example, in some embodiments, the coating 222 is applied to the first side 310 of the first substrate 308, and the ink layer 302 is then printed onto a first surface of the coating 222.

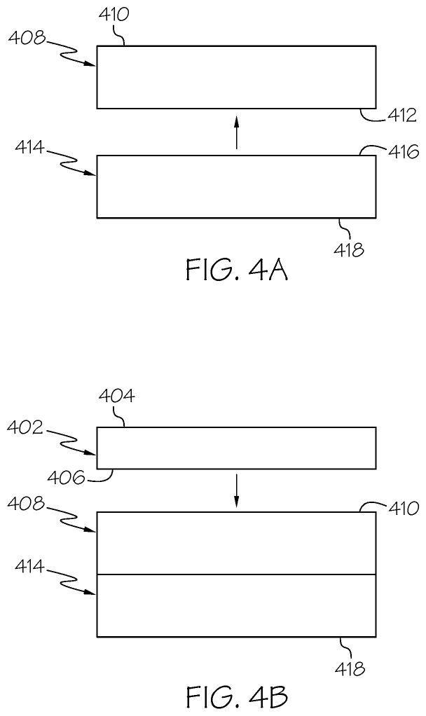

In some embodiments, such as in FIGS. 4B-4B, some methods of manufacturing a heat-bondable laminate include laminating a first substrate 408 and a second substrate 414 are laminated together before an ink layer 402 is printed onto the first substrate. For example, in some embodiments, a first operation and as shown in FIG. 4A, the second substrate 414 comprising a heat activatable adhesive and having a first side 416 and a second side 418 is adhered to the first substrate 408, such that the first side 416 of the second substrate 414 is in contact with the second side 412 of the first substrate 408. The first substrate 408 and the second substrate 414 may then be laminated together, such as through the application of heat and/or pressure to one or both of the first substrate 408 and/or the second substrate 414. The ink layer 402 may then be at least partially adhered through digital printing onto the first side 410 of the first substrate 408, creating a heat-bondable printed laminate in accordance with some embodiments. In some embodiments, a coating (e.g., coating 220) may be disposed at least partially between the first side 410 of the first substrate 408 and the second side 406 of the ink layer 402.

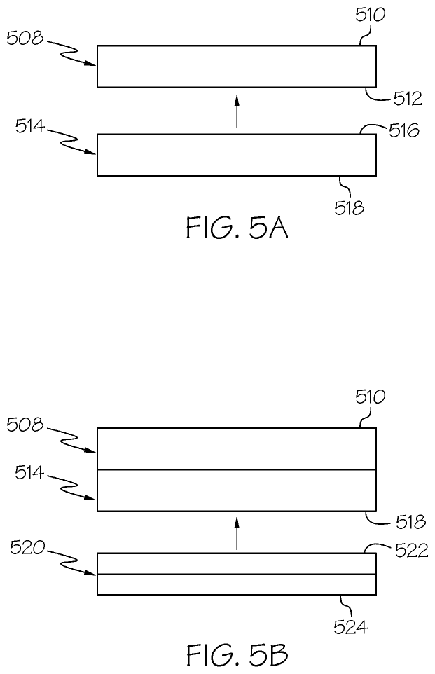

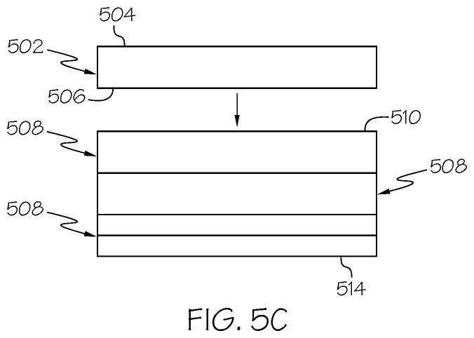

In some embodiments, such as in FIGS. 5A-5C, a first substrate 508 and a second substrate 514 are laminated together, an adhesive sandwich 520 may be attached to the second substrate 514, and an ink layer 502 may be printed onto the first substrate 508.

In various embodiments, the second side 518 of the second substrate 514 is in contact with the first side 522 of the adhesive sandwich 520. In some embodiments, the adhesive sandwich may be a laminate of an adhesive disposed on a paper or polymeric substrate. In some embodiments, the adhesive used in the adhesive sandwich 520 may include a pressure sensitive adhesive, such as an acrylic based pressure sensitive adhesive. In some embodiments, the adhesive sandwich may be used to provide support and height/thickness to the laminate of the first substrate 508 and the second substrate 514 to facilitate the ink printing process. After printing of ink 502 on the first substrate 508 is completed, the adhesive sandwich 520 may be peeled off before applying the second substrate 514 to a material, such as a fabric.

In various embodiments, as shown in FIG. 5A, a method may include adhering the second substrate 514 comprising a heat activatable adhesive and having a first side 516 and a second side 518 to the first substrate 508, such that the first side 516 of the second substrate 514 is in contact with the second side 512 of the first substrate 508. The first substrate 508 and the second substrate 514 may then be laminated. In some embodiments, in a second operation, the adhesive sandwich 520 having a first adhesive layer 522 and a second paper or polymeric substrate 524 may be adhered to the second substrate 514, such that the first adhesive layer 522 of the adhesive sandwich 520 is in contact with the first side 518 of the second substrate 514. In some embodiments and as shown in FIG. 5c, the ink layer 502 may be at least partially adhered through digital printing onto a first substrate 508 onto the first side 510 to produce a heat bondable printed laminate in accordance with some embodiments. A coating may be disposed at least partially between the first side 510 of the first substrate 508 and the second side 506 of the ink layer 502.

In accordance with some embodiments, in the operation of FIG. 5C, the ink 502 may be digitally printed onto the first substrate 508. Use of digital printing methods, which may include any electrophotographic printing such as ink-jet printing, laser printing, HP indigo printing, can reduce the set up times required to produce an improved image quality including resulting in reduced costs and turnaround time between short print runs as compared to traditional screen printing. Also, digital printing may allow the use of graphic design software to create and manipulate designs much faster than when using the screen printing process, which may allow small batches to be printed without fear of minimum order quantity. Furthermore, the heat-bondable laminate which is designed to be printable in a digital printing press may allow high quality prints with wider color capabilities and increased substrate versatility. Unlike traditional printings, some embodiments may allow printing on a variety of commonly used such as cotton, polyester, and blended materials. For some embodiments, digital printing technologies may offer improvements in one or more of color, ink coverage, increased or decreased printing size, and/or improved clarity/resolution that can substantially exceed the quality of traditional printing used in printing fabrics and/or other materials.

For various embodiments, printing of the ink onto a material to be heat-bonded can be carried out in with the side of the ink for viewing being immediately available for viewing. In various embodiments, the upside is on top, unlike conventional methods for heat transfers, which require mirror-image printing onto a release layer. In such conventional methods for creating a heat transfer, printing is performed upside down, with the top of the ink for viewing being put in contact with a release layer on a release layer carrier, leaving the reverse image exposed for viewing. In some conventional methods, a powdered adhesive may be applied to the reverse image side of the ink. The combination of the carrier release layer, release layer, ink, and adhesive may then be applied to a fabric. Using application of heat, the adhesive may be bonded to a fabric. The ink, adhesive, and fabric may then be released from the release layer and/or the release layer carrier such as by pulling the release layer carrier away from the ink. In some conventional methods, the ink may be bonded differently with the adhesive than with some embodiments of this disclosure, resulting in a weaker adhesion that can allow the ink to be pulled away from the adhesive when the release layer carrier is pulled away from the adhesive. In addition, in some conventional methods, the ink may have a low resolution that results in images that are more coarse and/or crude than digitally printed images. In contrast, some methods of the present disclosure may allow manufacturers to directly print onto material such as a polymeric film, which can then be heat-bonded to other materials without one or more of the disadvantages of the conventional systems. Use of methods of some embodiments of the present disclosure may entirely avoid the use of a release coating and/or release coating carrier.

In some embodiments, the temperature for curing the ink may vary depending on one or more of the printing equipment used, the source of heat, the size of the heating element, the printing medium, the images created using the ink, the colors and composition of the ink, the material for receiving the heat-bondable image, and the details and degree of complexity provided in the image. In various embodiments, heat may be applied by raising ambient air temperature next to the ink, the ink, and/or the first substrate (e.g., the first substrate 508) to the target temperature. In various embodiments, heating may be accomplished through convection, conduction, and/or radiation such as by using heat lamps, an electric resistance heater, burning gas, and/or other methods.

In various embodiments, the curing temperature may be between approximately 200° F. to approximately 300° F. In some embodiments, the curing temperature may be in the range of 50°−75° F., 75°−100° F., 100°−125° F., 125°−150° F., 150°−175° F., 175°−200° F., 200°−225° F., 225°−250° F., 250°−275° F., 275°−300° F., 300°−325° F., 325°−350° F., 350°−375° F., 375°−400° F., 400°−425° F., or combinations of these ranges. In some embodiments, a temperature of between 235° and 245° F. may be used.

In some embodiments, the first substrate is formed at least in part from a material selected from the group consisting of or comprising a polyurethane, a polyester, and polyethylene terephthalate and combinations thereof.

In various embodiments, at least part of the second substrate may be or may comprise a heat activatable adhesive comprising a polyurethane adhesive, polyester adhesive, or combinations thereof. The heat activatable adhesive may be activated at a temperature in the range of 220 to 370° F. In various embodiments, the temperature for activating the heat activatable adhesive may be in the range of 125°−150° F., 150°−175° F., 175°−200° F., 200°−225° F., 225°−250° F., 250°−275° F., 275°−300° F., 300°−325° F., 325°−350° F., 350°−375° F., 375°−400° F., 400°−425° F., or combinations of these ranges.

In some embodiments, at least part of second substrate includes a heat-activated adhesive that is solid sheet that can be cut to appropriate shapes, stacked, and/or laminated to other layers such as the first substrate of various embodiments. Use of a solid sheet of heat-activated adhesive may provide benefits such as improvements in one or more uniformity, smoothness, speed of application, adhesion, appearance of the final commercial product, avoidance of excess adhesive leakage, better control of application, greater surface area of application, or other benefits. In some embodiments, at least part of the second substrate may include heat-activated adhesive that has the form of a powdered or liquid adhesive.

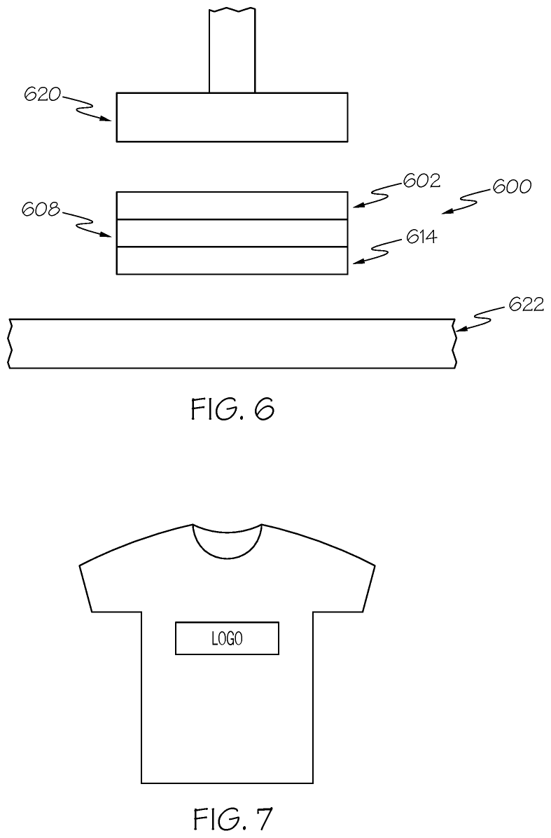

In various embodiments, such as in FIG. 6, a method for applying an image to a material may include one or more of the operations described below. The method may apply to applying a heat-bondable laminate to a fabric, metal, plastic, paper, cardboard, ceramic, film, wood, or other material. In some embodiments, a method involves positioning a heat-bondable laminate 600 of the present disclosure, over and/or on the material 622 (e.g., a fabric, plastic, metal, or other material), such that the second side of the second surface 614 is in contact with material 622. The second substrate 614 of the printed laminate 600 may then be activated by application of heat and/or pressure to bond the printed laminate 600 to the material 622. The press 620 may apply pressure and/or heat through conduction to the ink layer 602, the first substrate 608, and the heat activatable adhesive layer 614 to bond the laminate 600 to the material 622.

In various embodiments, such as in FIG. 7, at least part of the methods, materials, and items disclosed herein may be used to bond an image with an article of clothing such as a shirt. In other embodiments, one or more parts of the methods, materials, devices, and items disclosed herein may be used to bond images to articles such as laminates, films, fabrics, signs, vehicles, buildings, tools, paper, plastic, cardboard, shoes, jackets, furniture, electronic devices, phones, phone cases, or other items. The images may be formed from an ink layer that may be digitally printed, such as onto a laminate, a film, or other materials. The ink layer may be adhered directly or through other layers to a heat-activatable adhesive that is bonded to other materials and/or articles through the application of heat and/or pressure for a period of time as discussed above.

In various embodiments, the bonding temperature used to activate the second substrate of the printed laminate may vary depending on the type of hot pressing equipment used, the ink, the heat activatable adhesive, the thickness of one or more layers of the laminate including the ink, the first substrate, any coatings, and the material for bonding, the heat transfer properties of the various layers, or other factors. Some additional factors that may affect the bonding temperature and/or time for bonding may include the printing medium, whether the material includes one of a natural or a synthetic fabric, and the label, trademark, branding indicia, logo, symbol, product identification, specification material, or other words and images chosen by the manufacturer or purchaser, as well as the degree of complexity and detail of the printed image. In various embodiments, the bonding temperature used to activate the heat activatable adhesive may be between 125°−150° F., 150°−175° F., 175°−200° F., 200°−225° F., 225°−250° F., 250°−275° F., 275°−300° F., 300°−325° F., 325°−350° F., 350°−375° F., 375°−400° F., 400°−425° F., or combinations of these ranges.

In some embodiments, pressure may be applied to bond the image formed by an ink layer to a material. The pressure applied may be at least 20 psi, 30 psi, 40 psi, 50 psi, 60 psi, 70 psi, or 80 psi.

In some embodiments, heat and/or pressure is applied for a period of time to bond the image formed by an ink layer to a material. The bonding time may be between 10-50 seconds. In some embodiments, the bonding time may be in the range of 5-10, 10-15, 15-20, 20-30, 30-40, 40-50, 50-60, 60-90, or 90-120 seconds. In some embodiments, the bonding time may be in the range of 1-2, 2-3, 3-4, 4-5, 5-6, or 6-10 minutes.

In various embodiments, the material to which the ink layer and the heat-activatable adhesive may be bonded may be at least partly formed from cotton, polyester, a blend of cotton and polyester, fabric, wood, glass, metal, plastic, cardboard, ceramic, paper, or carbon fiber. For various embodiments, other materials may also be used.

Several advantages over other methods and systems may be achieved by using various parts or aspects the various materials, devices, and methods described in this disclosure for using heat-activatable adhesives to bond images formed from ink to various materials. For example, for some of the materials and methods described herein may allow for one or more of improved efficiency, speed, image quality, and precision, while reducing cost, thus making small orders of printed fabrics or other materials practical. Several embodiments may reduce operational time in preparing the final articles during their manufacture. In addition, some embodiments may allow ink to bind more deeply with a heat-activatable adhesive layer and/or a material to which the adhesive is bonded, such as a naturally or synthetically based fabric. The improved binding may improve design visibility, and may also leave less substrate residue on the surface of a material, such as fabric than conventional methods.

### Experimental Details

Four different bonding conditions were tested, with the pressure used to press the printed laminate to the fabric being kept constant at approximately 40 psi for each test. The printed laminate was bonded at either 302° F. for 25 seconds, 320° F. for 25 seconds, 302° F. for 10 seconds, or 266° F. for 10 seconds. After the printed laminate was bonded to the fabric, the fabric underwent the AATCC At Home Wash test to demonstrate the durability of the bonded printed laminate. Table 1 illustrates the results.

TABLE 1

| Bonding Conditions | | | | | | No of | | |
|---|---|---|---|---|---|---|---|---|
| Temp. | Pressure | Time | Fabric | | | wash | Condition of | |
| ° F. | psi | sec | Type | Ink | Ink Colors | cycles | wash | Results |
| 302 | 40 | 25 | 50/50 | Epson | Yellow, Magenta, | 25 | AATCC at | PASS |
| | | | blend | ultrachrome | Cyan | | home wash | |
| | | | | GS3 | | | test | |
| 302 | 40 | 25 | Cotton | Epson | Yellow, Magenta, | 25 | AATCC at | PASS |
| | | | | ultrachrome | Cyan | | home wash | |
| | | | | GS3 | | | test | |
| 302 | 40 | 25 | polyester | Epson | Yellow, Magenta, | 25 | AATCC at | PASS |
| | | | | ultrachrome | Cyan | | home wash | |
| | | | | GS3 | | | test | |
| 302 | 40 | 25 | 50/50 | Roland Eco- | Yellow, Magenta, | 25 | AATCC at | PASS |
| | | | blend | Sol | Cyan | | home wash | |
| | | | | | | | test | |
| 302 | 40 | 25 | Cotton | Roland Eco- | Yellow, Magenta, | 25 | AATCC at | PASS |
| | | | | Sol | Cyan | | home wash | |
| | | | | | | | test | |
| 302 | 40 | 25 | polyester | Roland Eco- | Yellow, Magenta, | 25 | AATCC at | PASS |
| | | | | Sol | Cyan | | home wash | |
| | | | | | | | test | |
| 320 | 40 | 25 | 50/50 | Roland Eco- | Yellow, Magenta, | 25 | AATCC at | PASS |
| | | | blend | Sol | Cyan | | home wash | |
| | | | | | | | test | |
| 320 | 40 | 25 | Cotton | Roland Eco- | Yellow, Magenta, | 25 | AATCC at | PASS |
| | | | | Sol | Cyan | | home wash | |
| | | | | | | | test | |
| 320 | 40 | 25 | polyester | Roland Eco- | Yellow, Magenta, | 25 | AATCC at | PASS |
| | | | | Sol | Cyan | | home wash | |
| | | | | | | | test | |
| 320 | 40 | 25 | 50/50 | Epson | Yellow, Magenta, | 25 | AATCC at | PASS |
| | | | blend | ultrachrome | Cyan | | home wash | |
| | | | | GS3 | | | test | |
| 320 | 40 | 25 | Cotton | Epson | Yellow, Magenta, | 25 | AATCC at | PASS |
| | | | | ultrachrome | Cyan | | home wash | |
| | | | | GS3 | | | test | |
| 320 | 40 | 25 | polyester | Epson | Yellow, Magenta, | 25 | AATCC at | PASS |
| | | | | ultrachrome | Cyan | | home wash | |
| | | | | GS3 | | | test | |
| 302 | 40 | 10 | 50/50 | Epson | Yellow, Magenta, | 25 | AATCC at | PASS |
| | | | blend | ultrachrome | Cyan | | home wash | |
| | | | | GS3 | | | test | |
| 302 | 40 | 10 | Cotton | Epson | Yellow, Magenta, | 25 | AATCC at | PASS |
| | | | | ultrachrome | Cyan | | home wash | |
| | | | | GS3 | | | test | |
| 302 | 40 | 10 | polyester | Epson | Yellow, Magenta, | 25 | AATCC at | PASS |
| | | | | ultrachrome | Cyan | | home wash | |
| | | | | GS3 | | | test | |
| 302 | 40 | 10 | 50/50 | Roland Eco- | Yellow, Magenta, | 25 | AATCC at | PASS |
| | | | blend | Sol | Cyan | | home wash | |
| | | | | | | | test | |
| 302 | 40 | 10 | Cotton | Roland Eco- | Yellow, Magenta, | 25 | AATCC at | PASS |
| | | | | Sol | Cyan | | home wash | |
| | | | | | | | test | |
| 302 | 40 | 10 | polyester | Roland Eco- | Yellow, Magenta, | 25 | AATCC at | PASS |
| | | | | Sol | Cyan | | home wash | |
| | | | | | | | test | |
| 266 | 40 | 10 | 50/50 | Roland Eco- | Yellow, Magenta, | 25 | AATCC at | FAIL |
| | | | blend | Sol | Cyan | | home wash | |
| | | | | | | | test | |
| 266 | 40 | 10 | Cotton | Roland Eco- | Yellow, Magenta, | 25 | AATCC at | FAIL |
| | | | | Sol | Cyan | | home wash | |
| | | | | | | | test | |
| 266 | 40 | 10 | polyester | Roland Eco- | Yellow, Magenta, | 25 | AATCC at | FAIL |
| | | | | Sol | Cyan | | home wash | |
| | | | | | | | test | |
| 266 | 40 | 10 | 50/50 | Epson | Yellow, Magenta, | 25 | AATCC at | FAIL |
| | | | blend | ultrachrome | Cyan | | home wash | |
| | | | | GS3 | | | test | |
| 266 | 40 | 10 | Cotton | Epson | Yellow, Magenta, | 25 | AATCC at | FAIL |
| | | | | ultrachrome | Cyan | | home wash | |
| | | | | GS3 | | | test | |
| 266 | 40 | 10 | polyester | Epson | Yellow, Magenta, | 25 | AATCC at | FAIL |
| | | | | ultrachrome | Cyan | | home wash | |
| | | | | GS3 | | | test | |

As illustrated in Table 1, the printed laminate remained bonded to the fabric while maintaining acceptable color in each case where the temperature was greater than 266° F. and in each case where heat and pressure were applied for more than 10 seconds. It was only when the printed laminates were bonded to the fabrics at a temperature of 266° F., with heat and pressure applied for only ten seconds that the printed laminates failed the wash test.

Accordingly, some embodiments may apply heat of over 266° F. and pressure of at least 40 psi for at least 10 seconds when bonding a printed laminate to a fabric. However, other temperatures, pressures, and time periods may be used as discussed within this disclosure.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

1. A heat-bondable printed laminate comprising:
an ink layer having a first side configured for viewing and a second side;
a first substrate having a first side and a second side, the second side of the ink layer being at least partially adhered through direct printing to the first side of the first substrate; and
a second substrate comprising a heat activatable adhesive and having a first side and a second side, the first side of the second substrate being at least partially laminated to and disposed on the second side of the first substrate.

2. The printed laminate as claimed in claim 1 further comprises a coating at least partially disposed between the first side of the first substrate and the second side of the ink layer.

3. The printed laminate as claimed in claim 1, wherein the thickness of the coating is in the range of 0.5 mil to 25 mil.

4. The printed laminate as claimed in claim 1, wherein the coating is vinyl containing polymeric film.

5. The printed laminate as claimed in claim 1, wherein the first substrate comprises a single layer polymeric film.

6. The printed laminate as claimed in claim 1, wherein the first substrate comprises a multi-layer polymeric laminate.

7. The printed laminate as claimed in claim 1, wherein the first substrate is formed from a material selected from the group consisting of a polyurethane, a polyester, and polyethylene terephthalate and combinations thereof.

8. The printed laminate as claimed in claim 1, wherein the ink is at least one selected from water based ink, solvent based ink, latex ink and eco-solvent ink.

9. The printed laminate as claimed in claim 1, wherein the ink comprises eco-solvent ink.

10. The printed laminate as claimed in claim 1, wherein the ink comprises polyurethane ink, polyacrylate ink, or combinations thereof.

11. The printed laminate as claimed in claim 1, wherein the ink layer comprises one color.

12. The printed laminate as claimed in claim 1, wherein the ink layer comprises more than one color.

13. The printed laminate as claimed in claim 1, wherein the adhesive layer comprises heat activatable adhesive.

14. The printed laminate as claimed in claim 13, wherein the heat activatable adhesive coating is activated at a temperature in the range of 270 to 370° F.

15. The printed laminate as claimed in claim 1, wherein the adhesive coating comprises a polyurethane adhesive, a polyester adhesive, or combinations thereof.

16. A method of manufacturing a heat-bondable laminate, comprising:
printing an ink layer onto a first side of a first substrate;
curing the ink at a temperature in the range of 200° to 300° F.;
disposing a first side of a second substrate in contact with a second side of the first substrate, the second substrate comprising a heat activatable adhesive and having a first side and a second side onto the first substrate; and
laminating the first substrate and the second substrate together.

17. The method of claim 16, wherein the first substrate and the second substrate are laminated together before the ink layer is printed onto the first substrate.

18. The method of claim 16, wherein the first substrate and the second substrate are laminated together after the ink layer is printed onto the first substrate.

19. The method of claim 16, wherein the ink is digitally printed onto the first substrate.

20. The method of claim 16, further comprising:
applying a coating on the first side of the first substrate before printing the ink layer.

21. The method as claimed in claim 20, wherein the coating comprises vinyl containing polymeric film having thickness in the range of 0.5 to 25 mils.

22. The method of claim 16, wherein the first substrate is formed from a material selected from the group consisting of a polyurethane, a polyester, and polyethylene terephthalate and combinations thereof.

23. The method of claim 16, wherein the ink is at least one selected from water based ink, solvent based ink, latex ink and eco-solvent ink.

24. The method as claimed in claim 23, wherein the ink layer comprises polyurethane ink, polyacrylate ink, or combinations thereof.

25. The method of claim 16, wherein the second substrate includes an adhesive comprising a polyurethane adhesive, polyester adhesive, or combinations thereof.

26. A method for applying an image to a material, the method comprising:
positioning a heat-bondable laminate, over a material, the heat-bondable laminate having an ink layer, a first substrate, and a second substrate, the ink layer having a first side configured for viewing and a second side at least partially adhered to a first side of the first substrate, the first substrate having a second side at least partially laminated to a first side of the second substrate that comprises a heat activatable adhesive, the positioning of the heat-bondable laminate placing the second side of the second substrate in contact with the material;
applying heat and pressure to the printed laminate and the material to bond the printed laminate to the material.

27. The method as claimed in claim 26, wherein the heat applied to the printed laminate and the material is between 270 and 370° F.

28. The method as claimed in claim 26, wherein the pressure applied to the printed laminate and the material is at least 40 psi.

29. The method as claimed in claim 26, wherein the heat and pressure is applied to the printed laminate and the material for time in the range of 10 to 50 seconds.

30. The method as claimed in claim 26, wherein the material comprises cotton, polyester, a blend of cotton and polyester, fabric, wood, glass, metal, plastic, cardboard, ceramic, or carbon fiber.

31. The method as claimed in claim 26, wherein the heat and pressure is applied to the printed laminate and the material for time exceeding 10 seconds.
